(19) United States
(12) Patent Application Publication
(10) Pub. No.: US 2026/0112386 A1
(43) Pub. Date: Apr. 23, 2026

(54) SELECTIVE AUDIO SIGNAL ENHANCEMENT BASED ON AUDIO AND VISUAL INFORMATION

(71) Applicant: BOSE CORPORATION, Framingham, MA (US)

(72) Inventors: Sile YIN, Westborough, MA (US); Shuo ZHANG, Belmont, MA (US); Colin Douglas FLETCHER, Needham, MA (US); Li-Chia YANG, Chelmsford, MA (US); Tun-Min HUNG, Pittsburgh, PA (US); Teng MA, Brookline, MA (US)

(21) Appl. No.: 19/360,786

(22) Filed: Oct. 16, 2025

Related U.S. Application Data
(60) Provisional application No. 63/708,571, filed on Oct. 17, 2024.

(51) Int. Cl. G10L 21/0364; G10L 21/034; G10L 21/0356; G10L 25/57; G11B 27/10

(52) U.S. Cl. CPC G10L 21/0364; G10L 21/034; G10L 21/0356; G10L 25/57; G11B 27/10

(57) ABSTRACT

Techniques, including devices and systems implementing the techniques, for selective audio signal enhancement based on audio and visual information. One example audio device generally includes one or more processors. The one or more processors, individually or collectively, are generally configured to receive an audio signal, receive visual information associated with the audio signal, and adjust, based on the audio signal and the visual information, at least a portion of the audio signal. In some cases, the adjusting may include using a trained machine-learning model to (i) identify the at least the portion of the audio signal based on the audio signal and the visual information, and (ii) isolate (e.g., amplify) the a portion of the audio signal (e.g., a target portion of the audio signal) while at least partially minimizing a remaining portion of the audio signal based on the audio signal and the visual information.

### CROSS-REFERENCE TO RELATED APPLICATION

This application claims the benefit of and priority to U.S. Provisional Application No. 63/708,571, filed Oct. 17, 2024, which is incorporated by reference herein in its entirety.

### FIELD

Aspects of the disclosure generally relate to devices, and, more particularly to techniques and audio devices for selective audio signal enhancement based on audio and visual information.

### BACKGROUND

Audio devices such as headphones commonly receive an input audio signal that may include speech and non-speech (e.g., sneezing, crying, laughing, alarms, sirens, sound associated with transportation, and/or other ambient sounds present in the environment surrounding the audio device). The audio devices may process the input audio signal to produce a desirable output audio signal for a user (or users) of the audio device. However, it is often challenging for the audio device to differentiate between the portion of the input audio signal that is important to the user and the portion of the input audio signal that is unimportant to the user. Thus, the audio device may struggle to amplify the portion of the input audio signal the user desires to hear while minimizing the remaining undesirable portion of the input audio signal the user. As a result, audio devices may struggle to provide an optimal audio signal to the user.

Accordingly, methods for providing improved output audio, as well as apparatuses and systems configured to implement these methods, are desired.

### SUMMARY

All examples and features mentioned herein can be combined in any technically possible manner.

Aspects of the present disclosure provide an audio device. The audio device generally includes one or more processors. The one or more processors, individually or collectively, are configured to: receive an audio signal, receive visual information associated with the audio signal, and adjust, based on the audio signal and the visual information, at least a portion of the audio signal.

In aspects, the one or more processors are configured, individually or collectively, to adjust the at least the portion of the audio signal by using a trained machine-learning model to identify, based on the audio signal and the visual information, the at least the portion of the audio signal.

In aspects, the one or more processors are further configured, individually or collectively, to: encode, using a pretrained audio encoder, the audio signal, encode, using a pretrained video encoder, the visual information, and align, in a time domain, the encoded audio signal and the encoded visual information.

In aspects, the audio device further includes: one or more visual sensors, where the one or more processors are configured, individually or collectively, to receive the visual information using the one or more visual sensors, and one or more audio sensors, where the one or more processors are configured, individually or collectively, to receive the audio signal using the one or more audio sensors.

In aspects, the one or more visual sensors include a camera configured to view an area external to a user of the audio device.

In aspects, the visual information includes facial movement information associated with speech from a speaker, and where the audio signal includes a speech component associated with the speech and a non-speech component.

In aspects, the one or more processors are configured, individually or collectively, to adjust, based on the audio signal and the facial movement information, the at least the portion of the audio signal by amplifying the speech component.

In aspects, the one or more processors are further configured, individually or collectively, to adjust, based on the audio signal and the facial movement information, the at least a portion of the audio signal by at least partially minimizing the non-speech component.

In aspects, the non-speech component includes at least one of: background speech not from the speaker, or environmental sound.

In aspects, the visual information includes information from an environment of the audio device, and where the audio signal includes a sound component associated with the sound and a non-sound component.

In aspects, the one or more processors are configured, individually or collectively, to adjust, based on the audio signal and the information from the environment of the device, the at least the portion of the audio signal by amplifying the sound component.

In aspects, the one or more processors are further configured, individually or collectively, to adjust, based on the audio signal and the information from the environment of the device, the at least a portion of the audio signal by at least partially minimizing the non-sound component.

In aspects, the audio device is included in a wearable device.

In aspects, the one or more processors are further configured, individually or collectively, to: output, for playback on the audio device, an output audio signal that includes the at least the portion of the audio signal.

In aspects, the visual information includes video information associated with speech from a speaker, and where the audio signal includes a speech component associated with the speech and a non-speech component.

In aspects, the one or more processors are configured, individually or collectively, to adjust, based on the audio signal and the video information, the at least the portion of the audio signal by amplifying the speech component.

In aspects, the one or more processors are further configured, individually or collectively, to adjust, based on the audio signal and the video information, the at least a portion of the audio signal by at least partially minimizing the non-speech component.

Aspects of the present disclosure are directed to a method for audio signal processing, substantially as herein described and exemplified with reference to the accompanying figures.

Aspects of the present disclosure provide a system for audio signal processing, substantially as herein described and exemplified with reference to the accompanying figures.

Aspects of the present disclosure provide a non-transitory computer-readable medium including computer-executable instructions that, when executed by one or more processors of a wearable device, cause the wearable device to perform a method for audio signal processing, substantially as herein described and exemplified with reference to the accompanying figures.

Aspects of the present disclosure provide a method. The method generally includes receiving an audio signal; receiving visual information associated with the audio signal; and adjusting, based on the audio signal and the visual information, at least a portion of the audio signal.

In aspects, adjusting the at least the portion of the audio signal includes using a trained machine-learning model to identify, based on the audio signal and the visual information, the at least the portion of the audio signal.

Aspects of the present disclosure provide a non-transitory computer-readable medium that includes computer-executable instructions that, when executed by one or more processors of a first device, cause the first device to perform a method. The method generally includes receiving an audio signal; receiving visual information associated with the audio signal; and adjusting, based on the audio signal and the visual information, at least a portion of the audio signal.

Two or more features described in this disclosure, including those described in this summary section, may be combined to form implementations not specifically described herein.

The details of one or more implementations are set forth in the accompanying drawings and the description below. Other features, objects, and advantages will be apparent from the description and drawings, and from the claims.

### BRIEF DESCRIPTION OF THE DRAWINGS

FIG. 1 illustrates an example system, in which aspects of the present disclosure may be implemented.

FIG. 2 illustrates another example system, in which aspects of the present disclosure may be implemented.

FIG. 3A illustrates an exemplary sound processing and playback device, in which aspects of the present disclosure may be implemented.

FIG. 3B illustrates an exemplary source device, in which aspects of the present disclosure may be implemented.

FIG. 4 illustrates an example of using audio and visual information for selective audio signal enhancement, in accordance with certain aspects of the present disclosure.

FIG. 5 illustrates example operations for audio signal processing, in accordance with certain aspects of the present disclosure.

FIG. 6 is a block diagram of an example process flow for selective audio signal enhancement during the audio signal processing of FIG. 5, according to certain aspects of the present disclosure.

FIG. 7 is a block diagram of an example process flow for a video encoder, according to certain aspects of the present disclosure.

FIGS. 8A and 8B illustrate example use cases for the selective audio signal enhancement of FIG. 6, in accordance with certain aspects of the present disclosure.

### DETAILED DESCRIPTION

Certain aspects of the present disclosure provide techniques, including devices and systems implementing the techniques, for selective audio signal enhancement based on audio and visual information. Such techniques may involve adjusting, based on both a received audio signal (e.g., which includes audio information) and received visual information associated with the audio signal, at least a portion of the audio signal. The audio signal may be received (e.g., captured) using one or more audio sensors (e.g., one or more external microphones), and the visual information may be received (e.g., captured) using one or more visual sensors (e.g., one or more cameras). In certain aspects, at least the portion of the audio signal may be adjusted by using a trained machine-learning model to (i) identify, using the audio signal and the visual information, the at least the portion of the audio signal, and (ii) isolate (e.g., amplify) at least the portion of the audio signal (e.g., a target portion of the audio signal) while at least partially minimizing (or at least partially rejecting) a remaining portion of the audio signal based on the audio signal and the visual information. In this manner, an optimal audio signal (with an isolated relevant or important portion of the audio signal) may be provided to a user (or users) of the audio device.

In some scenarios, a user may be wearing an audio device, such as headphones, in an environment (e.g., a public place, such as a restaurant), and may be attempting to converse with one or more individuals (referred to in these scenarios simply as the “speaker”) also present in the environment. Often times, both a speech component (e.g., speech from the speaker) and a non-speech component (e.g., sneezing, crying, laughing, alarms, sirens, competing speech from other people in the environment, and/or other ambient sounds present in the environment surrounding the audio device) may be present in the audio signal received by the audio device. The audio device may attempt to isolate the speech component to enable the user to clearly hear and more easily converse with the speaker. However, the audio device may struggle to identify and isolate the speech component in the received audio signal, due to the presence of sounds in the non-speech component. Aspects of the present disclosure may enable the audio device to (i) identify, in real-time, the speaker and the speaker's speech using the audio signal and visual information (e.g., facial movement, such as lip movement and the like) from one or more visual sensors and (ii), isolate the speech component while at least partially minimizing the non-speech component based on both the audio signal and the visual information. In this manner, the intelligibility of the speech of the speaker may be improved for the user of the audio device, even in the presence of competing sound and/or speech from other people in the environment.

In other scenarios, a user may be wearing an audio device, such as headphones, in an environment (e.g., a public place, such as a street), and there may be sounds in the environment that are relevant (e.g., important) for the user. Often times, both a relevant sound component (e.g., alarms, sirens, sound associated with transportation, speech, and the like) and a non-relevant sound component (e.g., speech, sneezing, crying, laughing, and/or other ambient sounds present in the environment surrounding the audio device) may be present in the audio signal received by the audio device. It is to be understood that the sounds relevant to the user may change from one situation to another, based on the environment of the user, as well as the user's preferences as configured in the audio device. The audio device may attempt to isolate the relevant sound component from the received audio signal for the user. However, the audio device may lack sufficient information to identify and isolate the relevant sound component from the audio signal, due to the presence of the sounds in the non-relevant component. Aspects of the present disclosure may enable the audio device to (i) identify, in real-time, the relevant sound component and the source of the relevant sound component using the audio signal and visual information from one or more visual sensors (e.g., information from the environment, such as blinking or flashing lights, vehicle movement, and the like) and (ii), isolate the relevant sound component while at least partially minimizing the non-relevant sound component based on both the audio signal and the visual information. In this manner, the intelligibility of the relevant or important sound may be improved for the user of the audio device, even in the presence of competing non-relevant or unimportant sounds in the environment.

In yet other scenarios, a user may be using an audio output device, such as a sound bar or a speaker of a laptop or cell phone, in an environment (e.g., a living room), and may be attempting to converse with one or more individuals (referred to simply in these scenarios as the “speaker”) online (e.g., via an online meeting or call). The audio output device may be used in conjunction with a display (e.g., a television, monitor, and the like) that may, in some cases, be portraying a live feed of the speaker. Often times, both a speech component (e.g., speech from the speaker) and a non-speech component (e.g., sneezing, crying, laughing, competing speech from other people around the speaker, and/or other ambient sounds present in the environment of the speaker) may be present in the audio signal received by the audio output device. The audio device may attempt to isolate the speech component to enable the user to clearly hear and more easily converse with the speaker. However, the audio device may struggle to identify and isolate the speech component in the received audio signal, due to the presence of the sounds in the non-speech component. Aspects of the present disclosure may enable the audio device to (i) identify, in real-time, the speaker and the speaker's speech using the audio signal and video information from a device used by the speaker (e.g., video information that includes facial movement of the speaker) and (ii), isolate the speech component while at least partially minimizing the non-speech component based on the audio signal and the video information. In this manner, the intelligibility of the speech of the speaker may be improved for the user of the audio device, even in the presence of competing sound and speech from other people in the environment.

In yet other scenarios, a user may be using an audio output device, such as a sound bar, in an environment (e.g., a living room), and may be attempting to enjoy movies, television shows, sports, games, music, podcasts, and other similar entertainment. The audio output device may be used in conjunction with a display (e.g., a television, monitor, and the like) that may show visuals associated with audio signals. Often times, the audio signal may include both a speech component (e.g., dialog from one or more speakers or singers) and a non-speech component (e.g., background music, action noise, and/or other audio in the entertainment). The audio device may attempt to isolate the speech component (for example, in a dialog mode) to enable the user to clearly hear the speech component. However, the audio device may struggle to identify and isolate the speech component in the received audio signal, due to the presence of the sounds in the non-speech component. Aspects of the present disclosure may enable the audio device to (i) identify, in real-time, the speech component using the audio signal and video information (e.g., video information that includes facial movement) and (ii), isolate the speech component while at least partially minimizing the non-speech component based on the audio signal and the video information. In this manner, the intelligibility of the speech of the speaker(s) may be improved for the user of the audio output device, even in the presence of competing sounds in the environment.

### An Example System

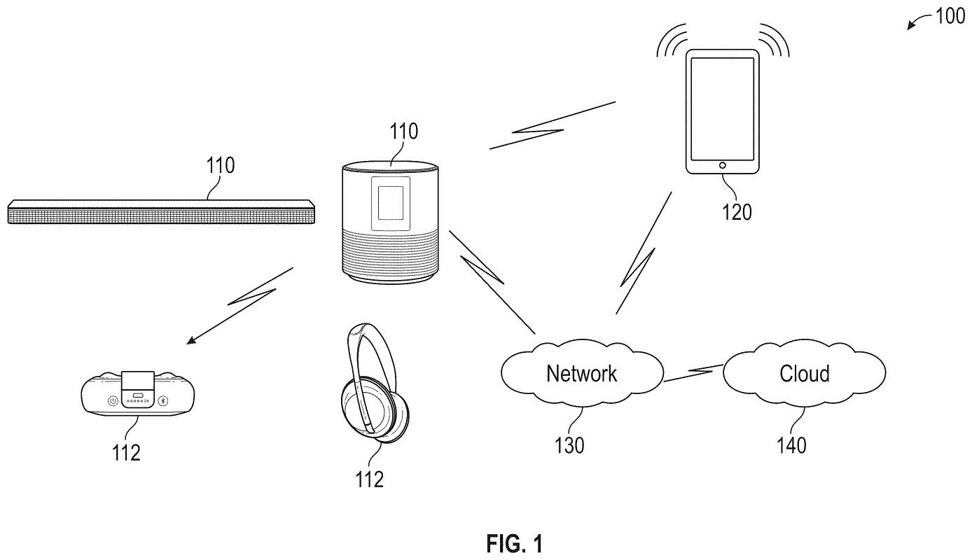

FIG. 1 illustrates an example system 100, in which aspects of the present disclosure may be implemented. As shown, system 100 includes one or more sound processing and playback devices 110 (e.g., a wireless audio device, such as a sound bar, a speaker, a smart speaker, a wearable device, and the like) communicatively coupled with a source device 120 (e.g., a computing device or user device, such as a smartphone, tablet computer, television, smart device, and the like). Throughout the present disclosure, the sound processing and playback device 110 may be referred to simply as the device 110. In the example of FIG. 1, the device 110 is shown implemented as both a sound bar and a smart speaker. One or more partner devices 112 (e.g., a portable speaker, a headset, and the like) may be available to accept pairing requests from the device 110 or the source device 120. The device 110 may be paired with the source device 120 and may receive content data (including audio signal(s)) from the source device 120. The device 110 may also receive content data directly from the network 130. The partner device 112 may be battery-powered portable devices suitable for mobile or privacy applications.

The device 110 may include hardware and circuitry including processor(s)/processing system and memory configured to implement one or more sound management capabilities or other capabilities including, but not limited to, noise cancelling circuitry (not shown) and/or noise masking circuitry (not shown), body movement detecting devices/sensors and circuitry (e.g., one or more accelerometers, one or more gyroscopes, one or more magnetometers, etc.), geolocation circuitry and other sound processing circuitry. The noise cancelling circuitry is configured to reduce unwanted ambient sounds external to the device 110 by using active noise cancelling (also known as active noise reduction). The sound masking circuitry is configured to reduce distractions by playing masking sounds via the speakers of the device 110. The movement detecting circuitry is configured to use devices/sensors such as an accelerometer, gyroscope, magnetometer, and the like to detect whether the user wearing the device 110 is moving (e.g., walking, running, in a moving mode of transport, etc.) or is at rest and/or the direction the user is looking or facing. The movement detecting circuitry may also be configured to detect a head position of the user for use in determining an event, as will be described herein, as well as in extended reality (XR) applications (e.g., virtual reality (VR) or augmented reality (AR) applications) where XR sounds are played back based, for example, on a direction of gaze of the user.

In certain aspects, the device 110 may be wirelessly connected to the source device 120 or the partner devices 112 using one or more wireless communication methods including, but not limited to, Bluetooth, Wi-Fi, Bluetooth Low Energy (BLE), other radio frequency (RF) based techniques, and the like. In certain aspects, the device 110 includes a transceiver that transmits and receives data via one or more antennae in order to exchange audio data and other information with the source device 120.

In certain aspects, the device 110 includes communication circuitry capable of transmitting and receiving audio data and other information from the source device 120. The device 110 also includes an incoming audio buffer, such as a render buffer, that buffers at least a portion of an incoming audio signal (e.g., audio packets) in order to allow time for retransmissions of any missed or dropped data packets from the source device 120. For example, when the device 110 receives Bluetooth transmissions from the source device 120, the communication circuitry typically buffers at least a portion of the incoming audio data in the render buffer before the audio is actually rendered and output as audio to at least one of the transducers (e.g., audio speakers) of the device 110. This is done to ensure that even if there are RF collisions that cause audio packets to be lost during transmission, that there is time for the lost audio packets to be retransmitted by the source device 120 before they have to be rendered by the device 110 for output by one or more acoustic transducers of the device 110.

One example of the partner device 112 is shown as noise-canceling headphones; however, the techniques described herein apply to other wireless audio devices, such as wearable audio devices, including any audio output device that fits around, on, in, or near an ear (including open-ear audio devices worn on the head or shoulders of a user) or other body parts of a user, such as head or neck. The partner device 112 may take any form, wearable or otherwise, including standalone alone devices (including automobile speaker system), stationary devices (including portable devices, such as battery powered portable speakers), headphones, earphones, earpieces, headsets, goggles, headbands, earbuds, armbands, sport headphones, neckband, hearing aids, or eyeglasses with integrated speaker(s).

In certain aspects, the device 110 is connected to the source device 120 using a wired connection, with or without a corresponding wireless connection. The source device 120 can be a smartphone, a tablet computer, a laptop computer, a digital camera, or other user device that connects with the device 110. As shown, the source device 120 can be connected to a network 130 (e.g., the Internet) and can access one or more services over the network. As shown, these services can include one or more cloud 140 services.

In certain aspects, the source device 120 can access a cloud server in the cloud 140 over the network 130 using a mobile web browser or a local software application or “app” executed on the source device 120. In certain aspects, the software application or “app” is a local application that is installed and runs locally on the source device 120. In certain aspects, a cloud server accessible on the cloud 140 includes one or more cloud applications that are run on the cloud server. The cloud application can be accessed and run by the source device 120. For example, the cloud application can generate web pages that are rendered by the mobile web browser on the source device 120. In certain aspects, a mobile software application installed on the source device 120 or a cloud application installed on a cloud server, individually or in combination, may be used to implement the techniques for low latency Bluetooth communication between the source device 120 and the device 110 in accordance with aspects of the present disclosure. In certain aspects, examples of the local software application and the cloud application include a gaming application, an audio XR application, and/or a gaming application with audio XR capabilities. The source device 120 may receive signals (e.g., data and controls) from the device 110 and send signals to the device 110.

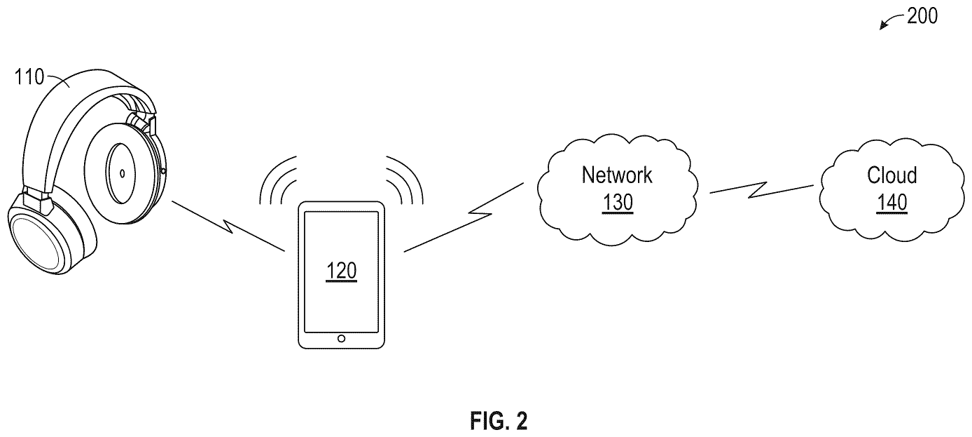

FIG. 2 illustrates another example system 200, in which aspects of the present disclosure may be implemented. In the example of FIG. 2, the sound processing and playback device 110 is shown implemented as a wearable device configured to be worn by a user, and may be a headset that includes two or more speakers, as illustrated in FIG. 2. At a high level, the device 110 may play audio content transmitted from the source device 120. The user may use the graphical user interface (GUI) on the source device 120 to select the audio content and/or adjust settings of the device 110. The device 110 provides soundproofing, active noise cancellation, and/or other audio enhancement features to play the audio content transmitted from the source device 120.

The device 110 is illustrated in FIG. 2 as over-the-head headphones; however, the techniques described herein apply to other wearable devices, such as wearable audio devices, including any audio output device that fits around, on, in, or near an ear (including open-ear audio devices worn on the head or shoulders of a user) or other body parts of a user, such as head or neck. The wearable device 110 may take any form, wearable or otherwise, including standalone devices (including automobile speaker system), stationary devices (including portable devices, such as battery powered portable speakers), headphones (including over-ear headphones, on-ear headphones, in-ear headphones), earphones, earpieces, headsets (including XR headsets), goggles, headbands, earbuds, armbands, sport headphones, neckbands, hearing aids, or eyeglasses.

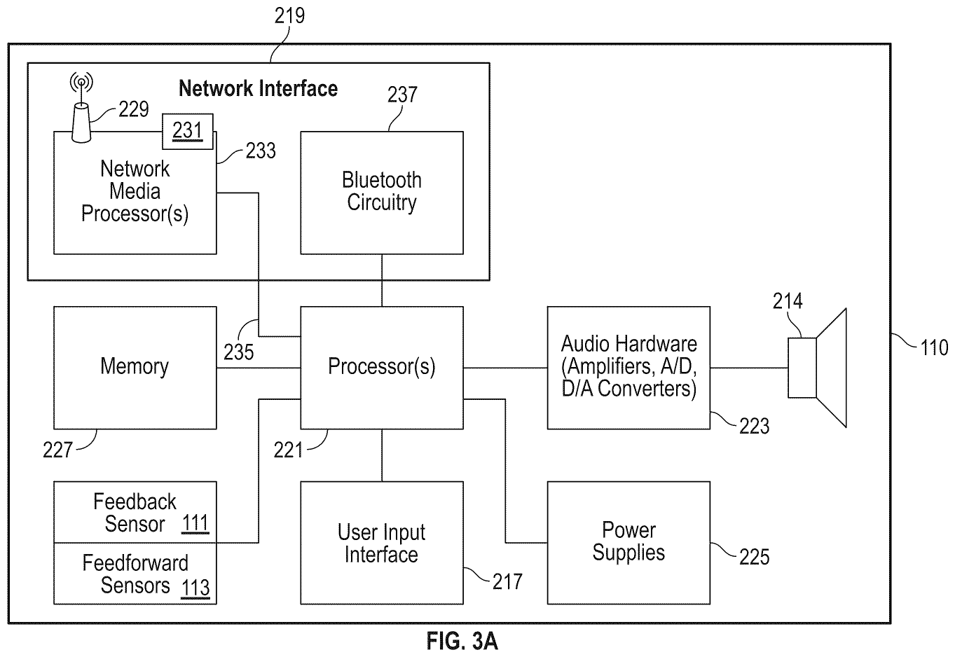

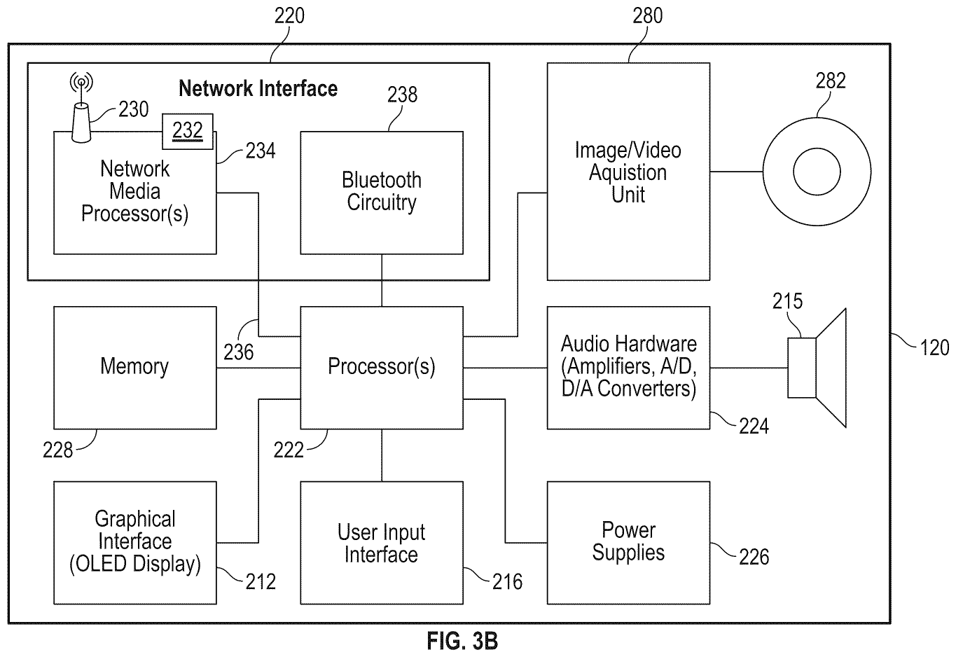

FIG. 3A illustrates an exemplary device 110 and some of its components. Other components may be inherent in the device 110 and not shown in FIG. 3A. For example, the device 110 may include an enclosure that houses an optional graphical interface (e.g., an organic light-emitting diode (OLED) display) which can provide the user with information regarding currently playing (“Now Playing”) music. In certain aspects, the partner device 112 may include components illustrated in FIG. 3A and described above.

The device 110 may include one or more electro-acoustic transducers (e.g., an acoustic driver or speaker) 214 for outputting audio. The device 110 may also include a user input interface 217. The user input interface 217 may include a plurality of preset indicators, which may be hardware buttons. The preset indicators may provide the user with easy, one press access to entities assigned to those buttons. The assigned entities may be associated with different ones of the digital audio sources such that a single device 110 may provide for single press access to various different digital audio sources.

The device 110 may include a feedback sensor 111 and feedforward sensor(s) 113. The feedback sensor 111 and the feedforward sensor(s) 113 may include two or more microphones for capturing ambient sound and provide audio signals for determining location attributes of events. The transmission delays may be used to reduce errors in subsequent computation. The feedforward sensor(s) 113 may provide two or more channels of audio signals. The audio signals are captured by microphones that are spaced apart and may have different directional responses. The two or more channels of audio signals may be used for calculating directional attributes of an event of interest.

As shown in FIG. 3A, the device 110 may include one or more electro-acoustic transducers (e.g., an acoustic driver or speaker) 214 to transduce audio signals to acoustic energy through audio hardware 223. The device 110 also may include a network interface 219, at least one processor 221, the audio hardware 223, power supplies 225 for powering the various components of the device 110, and memory 227. In certain aspects, the processor(s) 221, the network interface 219, the audio hardware 223, the power supplies 225, and the memory 227 are interconnected using various buses 235, and several of the components can be mounted on a common motherboard or in other manners as appropriate. In some cases, the at least one processor(s) 221 may be included in a controller.

The network interface 219 provides for communication between the device 110 and other electronic computing devices via one or more communications protocols, such as Bluetooth classic protocol, Bluetooth low energy protocol, and others. The network interface 219 provides either or both of a wireless network interface 229 and a wired interface 231. The wireless network interface 229 allows the device 110 to communicate wirelessly with other devices in accordance with a wireless communication protocol such as IEEE 802.11. The wired interface 231 provides network interface functions via a wired (e.g., Ethernet) connection for reliability and fast transfer rate, for example, used when the device 110 is not worn by a user. Although illustrated, the wired interface 231 is optional.

In certain aspects, the network interface 219 includes at least one network media processor 233 for supporting Apple AirPlay® and/or Apple Airplay® 2. For example, if a user connects an AirPlay® or Apple Airplay® 2 enabled device, such as an iPhone or iPad device, to the network, the user can then stream music to the network connected audio playback devices via Apple AirPlay® or Apple Airplay® 2. Notably, the audio playback device can support audio-streaming via AirPlay^{®}, Apple Airplay® 2 and/or Digital Living Network Alliance's (DLNA) Universal Plug and Play (UPnP) protocols, all integrated within one device.

All other digital audio received as part of network packets may pass straight from the at least one network media processor 233 through a universal serial bus (USB) bridge (not shown) to the processor(s) 221 and runs into the decoders, DSP, and eventually is played back (rendered) via the electro-acoustic transducer(s) 214.

The network interface 219 can further include Bluetooth circuitry 237 for Bluetooth applications (e.g., for wireless communication with a Bluetooth enabled audio source such as a smartphone or tablet) or other Bluetooth enabled speaker packages. In certain aspects, the Bluetooth circuitry 237 may be the primary network interface 219 due to energy constraints. For example, the network interface 219 may use the Bluetooth circuitry 237 solely for mobile applications when the wearable device 110 adopts any wearable form. For example, BLE technologies may be used in the wearable device 110 to extend battery life, reduce package weight, and provide high quality performance without other backup or alternative network interfaces.

In certain aspects, the network interface 219 supports communication with other devices using multiple communication protocols simultaneously at one time. For instance, the device 110 can support Wi-Fi/Bluetooth coexistence and can support simultaneous communication using both Wi-Fi and Bluetooth protocols at one time. For example, the device 110 can receive an audio stream from a smart phone using Bluetooth and can further simultaneously redistribute the audio stream to one or more other devices over Wi-Fi. In certain aspects, the network interface 219 may include only one RF chain capable of communicating using only one communication method (e.g., Wi-Fi or Bluetooth) at one time. In this context, the network interface 219 may simultaneously support Wi-Fi and Bluetooth communications by time sharing the single RF chain between Wi-Fi and Bluetooth, for example, according to a time division multiplexing (TDM) pattern.

Streamed data may pass from the network interface 219 to the processor(s) 221. The processor(s) 221 may execute instructions (e.g., for performing, among other things, digital signal processing, decoding, and equalization functions), including instructions stored in the memory 227. The processor(s) 221 may be implemented as a chipset of chips that includes separate and multiple analog and digital processors. The processor(s) 221 may provide, for example, for coordination of other components of the device 110, such as control of user interfaces.

The memory 227 may store software/firmware related to protocols and versions thereof used by the device 110 for communicating with other networked devices, including the source device 120. For example, the software/firmware governs how the device 110 communicates with other devices for synchronized playback of audio. In certain aspects, the software/firmware includes lower level frame protocols related to control path management and audio path management. The protocols related to control path management generally include protocols used for exchanging messages between speakers. The protocols related to audio path management generally include protocols used for clock synchronization, audio distribution/frame synchronization, audio decoder/time alignment, and playback of an audio stream. In certain aspects, the memory can also store various codecs supported by the speaker package for audio playback of respective media formats. In certain aspects, the software/firmware stored in the memory can be accessible and executable by the processor(s) 221 for synchronized playback of audio with other networked speaker packages.

In certain aspects, the protocols stored in the memory 227 may include BLE according to, for example, the Bluetooth Core Specification Version 5.2 (BT5.2). The device 110 and the various components therein are provided herein to sufficiently comply with or perform aspects of the protocols and the associated specifications. For example, BT5.2 includes enhanced attribute protocol (EATT) that supports concurrent transactions. A new L2CAP mode is defined to support EATT. As such, the device 110 may include hardware and software components sufficiently to support the specifications and modes of operations of BT5.2, even if not expressly illustrated or discussed in this disclosure. For example, the device 110 may utilize LE Isochronous Channels specified in BT5.2.

The processor(s) 221 provides a processed digital audio signal to the audio hardware 223 which includes one or more digital-to-analog (D/A) converters for converting the digital audio signal to an analog audio signal. The audio hardware 223 also includes one or more amplifiers which provide amplified analog audio signals to the electro-acoustic transducer(s) 214 for sound output. In addition, the audio hardware 223 may include circuitry for processing analog input signals to provide digital audio signals for sharing with other devices, for example, other speaker packages for synchronized output of the digital audio.

The memory 227 can include, for example, flash memory and/or non-volatile random-access memory (NVRAM). In certain aspects, instructions (e.g., software) are stored in an information carrier. The instructions, when executed by one or more processing devices (e.g., the processor(s) 221), perform one or more processes, such as those described elsewhere herein. The instructions can also be stored by one or more storage devices, such as one or more computer or machine-readable mediums (for example, the memory 227, or memory on the processor(s) 221). The instructions can include instructions for performing decoding (i.e., the software modules include the audio codecs for decoding the digital audio streams), as well as digital signal processing and equalization. In certain aspects, the memory 227 and the processor(s) 221 may collaborate in data acquisition and real time processing with the feedback sensor 111 and feedforward sensor(s) 113.

FIG. 3B illustrates an exemplary source device 120, such as a smartphone or a mobile computing device, in accordance with certain aspects of the present disclosure. Some components of the source device 120 may be inherent and not shown in FIG. 3B. For example, the source device 120 may include an enclosure. The enclosure may house an optional graphical interface 212 (e.g., an OLED display), as shown. The graphical interface 212 provides the user with information regarding currently playing (“Now Playing”) music or video. The source device 120 includes one or more electro-acoustic transducers 215 for outputting audio. The source device 120 may also include a user input interface 216 that enables user input.

The source device 120 also includes a network interface 220, at least one processor 222, audio hardware 224, power supplies 226 for powering the various components of the source device 120, and a memory 228. In certain aspects, the processor(s) 222, the graphical interface 212, the network interface 220, the audio hardware 224, the one or more power supplies 226, and the memory 228 are interconnected using the one or more buses 236, and several of the components can be mounted on a common motherboard or in other manners as appropriate. In certain aspects, the processor(s) 222 of the source device 120 is more powerful in terms of computation capacity than the processor(s) 221 of the device 110. Such difference may be due to constraints of weight, power supplies, and other requirements. Similarly, the power supplies 226 of the source device 120 may be of a greater capacity and heavier than the power supplies 225 of the device 110. In some cases, the at least one processor(s) 222 may be included in a controller.

The network interface 220 provides for communication between the source device 120 and the device 110, as well as other audio sources and other wireless speaker packages including one or more networked wireless speaker packages and other audio playback devices via one or more communications protocols. The network interface 220 can provide either or both of a wireless network interface 230 and a wired interface 232. The wireless network interface 230 allows the source device 120 to communicate wirelessly with other devices in accordance with a wireless communication protocol, such as IEEE 802.11. The wired interface 232 provides network interface functions via a wired (e.g., Ethernet) connection.

In certain aspects, the network interface 220 may also include at least one network media processor 234 and Bluetooth circuitry 238, similar to the at least one network media processor 233 and Bluetooth circuitry 237 in the device 110 in FIG. 3A. Further, in aspects, the network interface 220 supports communication with other devices using multiple communication protocols simultaneously at one time, as described with respect to the network interface 219 in FIG. 3A.

All other digital audio received as part of network packets comes straight from the at least one network media processor 234 through one or more buses 236 (e.g., USB bridge) to the at least one processor 222 and runs into the decoders, DSP, and eventually is played back (rendered) via the electro-acoustic transducer(s) 215.

The source device 120 may also include an image or video acquisition unit 280 for capturing image or video data. For example, the image or video acquisition unit 280 may be connected to one or more cameras 282 and capable of capturing still or motion images. The image or video acquisition unit 280 may operate at various resolutions or frame rates according to a user selection. For example, the image or video acquisition unit 280 may capture 4K videos (e.g., a resolution of 3840 by 2160 pixels) with the one or more cameras 282 at 30 frames per second, full high definition (FHD) videos (e.g., a resolution of 1920 by 1080 pixels) at 60 frames per second, or a slow motion video at a lower resolution, depending on hardware capabilities of the one or more cameras 282 and the user input. The one or more cameras 282 may include two or more individual camera units having respective lenses of different properties, such as focal length resulting in different fields of views. The image or video acquisition unit 280 may switch between the two or more individual camera units of the cameras 282 during a continuous recording.

Captured audio or audio recordings, such as the voice recording captured at the device 110, may pass from the network interface 220 to the processor(s) 222. The processor(s) 222 executes instructions within the wireless speaker package (e.g., for performing, among other things, digital signal processing, decoding, and equalization functions), including instructions stored in the memory 228. The processor(s) 222 can be implemented as a chipset of chips that includes separate and multiple analog and digital processors. The processor(s) 222 can provide, for example, for coordination of other components of the audio source device 120, such as control of user interfaces and applications. The processor(s) 222 provides a processed digital audio signal to the audio hardware 224 similar to the respective operation by the processor(s) 221 described in FIG. 3A.

The memory 228 can include, for example, flash memory and/or NVRAM. In certain aspects, instructions (e.g., software) are stored in an information carrier. The instructions, when executed by one or more processing devices (e.g., the processor(s) 222), perform one or more processes, such as those described herein. The instructions can also be stored by one or more storage devices, such as one or more computer or machine-readable mediums (for example, the memory 228, or memory on the processor(s) 222). The instructions can include instructions for performing decoding (i.e., the software modules include the audio codecs for decoding the digital audio streams), as well as digital signal processing and equalization.

### Example Operations for Selective Audio Signal Enhancement

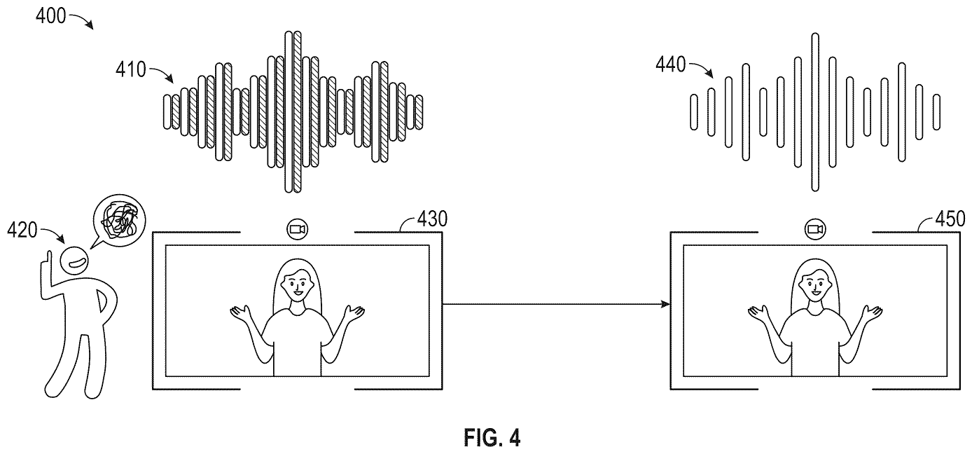

FIG. 4 illustrates an example of using audio and visual information for selective audio signal enhancement 400, in accordance with certain aspects of the present disclosure. Often times, and as described above, an audio signal 410 received at an audio device (e.g., device 110) may include both a speech component (e.g., speech from a target speaker or target speakers) and a non-speech component (e.g., sneezing, crying, laughing, alarms, sirens, sound associated with transportation, competing speech from other people in the environment, and/or other ambient sounds present in an environment surrounding the audio device). The non-speech component may, in some cases, be speech from one or more interfering (e.g., competing) speakers 420, as illustrated, making it challenging for the audio device to identify and isolate the speech component of the audio signal.

Certain aspects of the present disclosure may enable the audio device to (i) identify, in real-time, the target speaker(s) and the speech from the target speaker(s) based on the audio signal 410 (e.g., which includes audio information) and visual information 430 from one or more visual sensors included in the audio device and (ii), isolate the speech component while at least partially minimizing the non-speech component based on the audio signal and the visual information to produce an optimal output audio signal 440. The identifying may include, for example, using a trained machine-learning model to process the visual information 430 and correlate the resultant processed visual information 450, such as facial movement, from the target speaker with the speech component from the audio signal. In this manner, the intelligibility of the speech of the target speaker(s) may be improved for the user of the audio device, even in the presence of competing sounds and speech from other people in the environment.

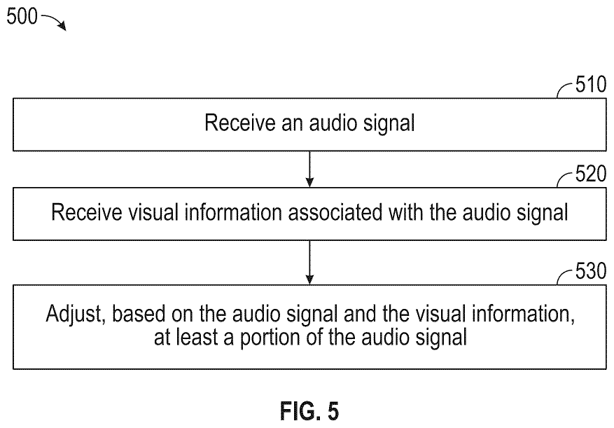

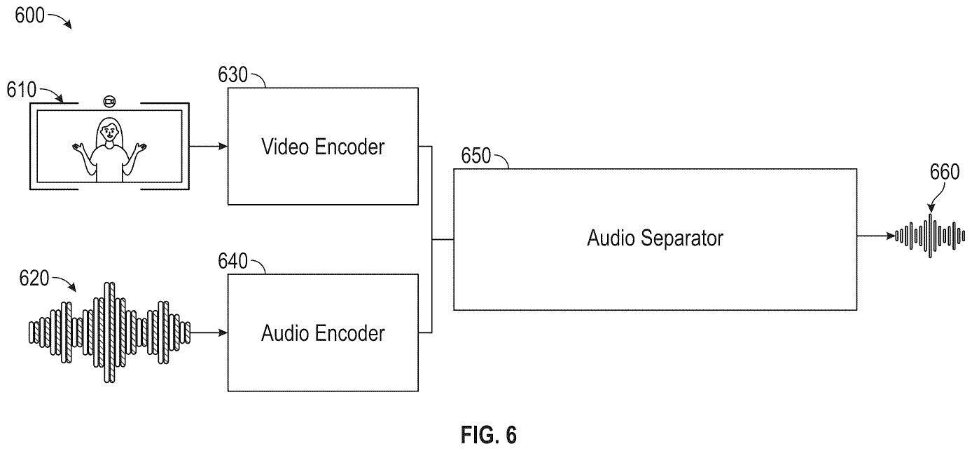

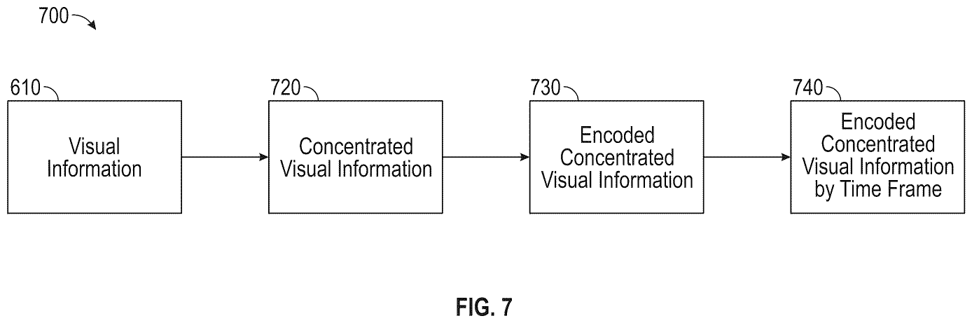

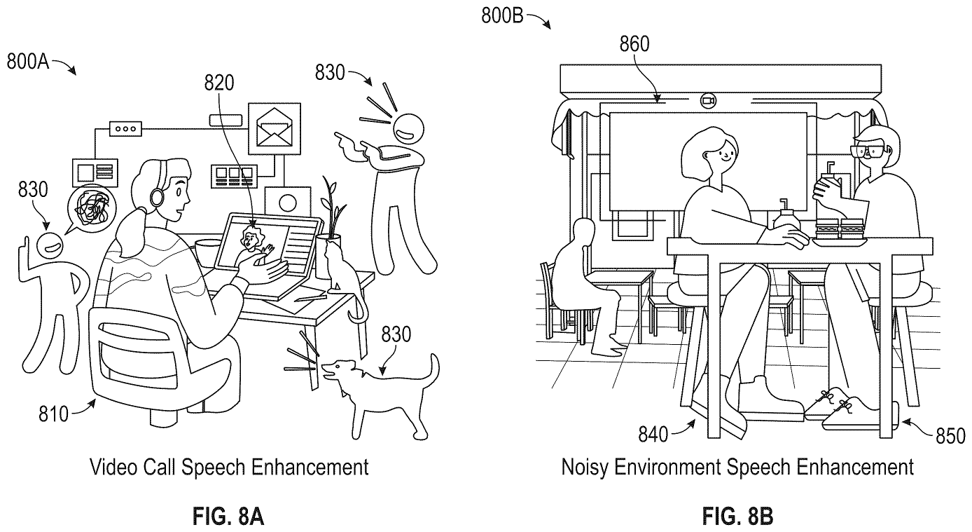

FIG. 5 illustrates example operations 500 for audio signal processing, in accordance with certain aspects of the present disclosure. FIG. 6 is a block diagram of an example process flow 600 for selective audio signal enhancement during the operations 500 of FIG. 5 for audio signal processing, according to certain aspects of the present disclosure. FIG. 7 is a block diagram of an example process flow 700 for a video encoder, according to certain aspects of the present disclosure. FIGS. 8A and 8B illustrate example use cases 800A, 800B for the selective audio signal enhancement of FIG. 6, in accordance with certain aspects of the present disclosure. Therefore, FIGS. 5, 6, 7, 8A, and 8B are herein described together for clarity.

The operations 500 may be performed by a device (e.g., an audio device, such as the device 110 of FIG. 1 and FIG. 2, which may be implemented as, for example, a sound bar, a speaker, or a smart speaker, a wearable device, and the like) or an accessory device (e.g., a source device 120, which may be implemented as, for example, a smartphone, tablet computer, television, smart device, and the like). For example, the operations 500 may be performed by the at least one processor(s) 221 included in the device 110 implemented as a speaker system (e.g., as illustrated in FIG. 1) or as a wearable device (e.g., as illustrated in FIG. 2). In this example, the speaker may be implemented in the device. In another example, the operations 500 may be performed by the at least one processor(s) 222 included in the source device 120 (e.g., as illustrated in FIG. 1). In this example, the speaker may be implemented in a different device (e.g., a speaker system) that is in communication with and configured to be controlled by the source device 120. When multiple processor(s) 221 or processor(s) 222 are included, the multiple processor(s) 221 and/or the multiple processor(s) 222 may perform the operations 500 individually or collectively.

The operations 500 may include, at block 510, receiving an audio signal 620. The audio signal 620 may be received using one or more audio sensors included in the device 110. The one or more audio sensors may be implemented by, for example, one or more external microphones. As described above, the audio signal 620 may include any combination of speech, sneezing, crying, laughing, alarms, sirens, sound associated with transportation, competing speech from other people in the environment, and/or other ambient sounds present in the environment surrounding the device 110.

At block 520, the operations 500 may include receiving visual information 610 associated with the audio signal 620. The visual information 610 may be received using one or more visual sensors of the device 110. The one or more visual sensors may be implemented by, for example, one or more cameras. In certain aspects, the one or more visual sensors may be included in and coupled to the device 110. In other aspects, the one or more visual sensors may be communicatively coupled to the device 110 and located external to the device 110. The one or more visual sensors may be configured to view the environment surrounding (e.g., external to) a user of the device 110. In some cases, at least one of the one or more visual sensors may be movable and/or adjustable, and may track people or certain objects (e.g., using a trained machine learning model or as controlled by a user), whereas in other cases, at least one of the one or more visual sensors may be fixed to a certain view or perspective.

According to certain embodiments, the operations 500 may include (i) encoding, using a pretrained audio encoder 640, the audio signal 620, (ii) encoding, using a pretrained video encoder 630, the visual information 610, and (iii) aligning, in the time domain, the encoded audio signal 620 and the encoded visual information 610. The aligning may occur before the encoded audio signal 620 and the encoded visual information 610 are provided to the audio separator 650. The audio encoder 640 may be implemented with a trained machine-learning model, and the video encoder 630 may also be implemented with the same or a different trained machine-learning model.

In some embodiments, the video encoder 630 may receive the visual information 610 and perform processing on the visual information 610, as illustrated in FIG. 7. The processing may include removing the unimportant portions of the visual information 610 to form concentrated visual information 720. In some cases, the visual information 610 may include video information of an environment that includes several objects and/or people, and the video encoder may crop the video information such that only the most relevant parts of the video information remain. For example, the video encoder 630 may crop the video information such that only the parts of the video information associated with lip movement of a target speaker (or target speakers) remain. The video encoder 630 may also encode the concentrated visual information 720 to form the encoded concentrated visual information 730. The video encoder 630 may further provide the encoded concentrated visual information by time frame 740, such that the encoded concentrated visual information by time frame 740 and the encoded audio signal 620 may be aligned in the time domain.

At block 530, the operations 500 may include adjusting, based on the audio signal 620 and the visual information 610, at least a portion of the audio signal 620. In some cases, only some portion of the audio signal 620 may be adjusted, whereas in other cases, the entirety of the audio signal 620 may be adjusted. It is to be understood that the adjusting at block 530 may include isolating any type or category of sound in the audio signal 620, depending on, for example, the environment of the device 110 and/or device user's preferences as configured in the device 110. That is, the adjusting at block 530 may include isolating speech, transportation sounds, alarms, sirens, music, or any sound (or combination of sound) that may be included in the audio signal received at block 510 (e.g., a target sound) using the visual information 610 in addition to the audio signal 620 (and in some cases, at least partially minimizing non-target sounds included in the audio signal 620). In this manner, the relevant and important parts of the audio signal 620 that are of interest to the user (or users) of the device 110 may be selectively enhanced to improve the intelligibility of the relevant and important parts of the audio signal 620 for the user.

In one example, and as illustrated in FIG. 8A, the adjusting at block 530 may include isolating the speech of an individual 820 in the audio signal that the user (user 810 in FIG. 8A) is communicating (e.g., talking) with online, while at least partially minimizing any non-speech 830 from around the user 810 in the audio signal, such that the user 810 may be able to easily hear and converse with the individual 820. In order to maximize the identification of the individual 820 and the individual's speech, and as described herein, the adjusting at block 530 may utilize video information (e.g., video source information from a display, such as a computer) in addition to the audio signal to identify and isolate the speech of the individual 820.

In another example, and as illustrated in FIG. 8B, the adjusting at block 530 may include isolating the speech of an individual 840 in the audio signal that the user (e.g., user 850 in FIG. 8B) is communicating (e.g., talking) with, while at least partially minimizing any non-speech in the audio signal, such that the user 850 may be able to easily hear and converse with the individual 840. In order to maximize the identification of the individual 840 and the individual's speech, and as described herein, the adjusting at block 530 may utilize visual information 860 (e.g., facial movement, such as the lip movement of the individual, captured using one or more visual sensors) in addition to the audio signal to identify and isolate the speech of the individual 840.

According to certain embodiments, the adjusting at block 530 may include using an audio separator 650 to identify, based on the audio signal 620 and the visual information 610, the at least the portion of the audio signal. The audio separator 650 may include or be implemented by a trained machine-learning model, which may be configured to process and correlate the encoded visual information 610 and the encoded audio signal 620. The audio separator 650 may integrate both visual and audio cues (from the visual information 610 and audio signal 620, respectively) to enhance the at least a portion of the audio signal 620. The adjusting at block 530 may include isolating (e.g., amplifying) a portion of the audio signal 620 and at least partially minimizing of a remaining portion of the portion of the audio signal 620, as described herein. In certain aspects, various parts of the visual information 610 may all be analyzed collectively to better perform the isolating and the at least partially minimizing during the adjusting at block 530. In some cases, the audio separator 650 may use a mask-based fusion model to integrate the visual and audio cues.

Any of the trained machine-learning models described herein may be pre-trained before operation of the device 110 and may be implemented by deep learning models. The trained machine-learning models may use various machine learning techniques based on artificial neural networks. For example, the video encoder 630, the audio encoder 640, and/or the audio separator 650, when implemented as a deep learning model, may include deep learning architectures, such as deep neural networks, deep belief networks, deep reinforcement learning, recurrent neural networks, convolutional neural networks, transformers, and the like.

In some cases, the visual information 610 may include facial movement information associated with speech from a speaker (e.g., lip movement), and the audio signal 620 may include a speech component associated with the speech (e.g., speech from the speaker) and a non-speech component. In these cases, the adjusting at block 530 may include amplifying (e.g., isolating) the speech component. In addition, the adjusting at block 530 may also include at least partially minimizing the non-speech component. The non-speech component may include at least one of background speech not from the speaker or environmental sound(s). For example, the non-speech component may include sneezing, crying, laughing, alarms, sirens, competing speech from other people in the environment, and/or other ambient sounds present in the environment surrounding the audio device.

In some cases, the visual information 610 may include information from the environment of the device, and the audio signal 620 may include a sound component associated with the sound and a non-sound component. In these cases, the adjusting at block 530 may include amplifying (e.g., isolating) the sound component. In addition, the adjusting at block 530 may also include at least partially minimizing the non-sound component. The sound component may include a sound relevant and important to the user of the device, such as alarms, sirens, sound associated with transportation, speech, and the like. In some cases, the information from the environment of the device may be indicative of the sound (e.g., blinking or flashing lights associated with an emergency siren), whereas in other cases, the information from the environment of the device may be associated with an event that is relevant or important to the user of the device 110 (e.g., a car approaching the user, passing the user, and then moving away from the user). In yet other cases, the information from the environment of the device may include both information indicative of the sound and information from the environment of the device may be associated with an event. The non-sound component may include at least one of speech or environmental sound(s). For example, the non-sound component may include speech, sneezing, crying, laughing, and/or other ambient sounds present in the environment surrounding the audio device.

In some cases, the visual information 610 may include video information associated with speech from a speaker (e.g., video source information from a display, such as a television, monitor, and the like), and the audio signal 620 may include a speech component associated with the speech (e.g., speech from the speaker) and a non-speech component. In these cases, the adjusting at block 530 may include amplifying the speech component. In addition, the adjusting at block 530 may also include at least partially minimizing the non-speech component. The non-speech component may include at least one of background speech not from the speaker or environmental sound. For example, the non-speech component may include sneezing, crying, laughing, competing speech from other people around the speaker, and/or other ambient sounds present in the environment of the speaker.

According to certain embodiments, the operations 500 may further include outputting, for playback on the device 110, an output audio signal 660 that includes the at least the portion of the audio signal. In this manner, an optimal output audio signal 660 (with an isolated relevant or important portion of the audio signal) may be provided to a user (or users) of the device 110.

In certain aspects, the device 110 may utilize audio spatialization to help represent the origin of the various parts of the received audio signal 620 in the output audio signal 660, to help assist the user of the device 110 in knowing the origin of various parts of the audio signal. For example, the aspects described herein may utilize audio spatialization to help draw the user's attention to the direction of speech, an alarm, a siren, or other relevant sound in the audio signal 620.

### Additional Considerations

It is noted that, descriptions of aspects of the present disclosure are presented above for purposes of illustration, but aspects of the present disclosure are not intended to be limited to any of the disclosed aspects. Many modifications and variations will be apparent to those of ordinary skill in the art without departing from the scope and spirit of the described aspects.

In the preceding, reference is made to aspects presented in this disclosure. However, the scope of the present disclosure is not limited to specific described aspects. Aspects of the present disclosure can take the form of an entirely hardware aspect, an entirely software aspect (including firmware, resident software, micro-code, etc.) or an aspect combining software and hardware aspects that can all generally be referred to herein as a “component,” “circuit,” “module” or “system.” Furthermore, aspects of the present disclosure can take the form of a computer program product embodied in one or more computer readable medium(s) having computer readable program code embodied thereon.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

Any combination of one or more computer readable medium(s) can be utilized. The computer readable medium can be a computer readable signal medium or a computer readable storage medium. A computer readable storage medium can be, for example, but not limited to, an electronic, magnetic, optical, electromagnetic, infrared, or semiconductor system, apparatus, or device, or any suitable combination of the foregoing. More specific examples of a computer readable storage medium include: an electrical connection having one or more wires, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the current context, a computer readable storage medium can be any tangible medium that can contain, or store a program. For example, the computer readable storage medium can contain, for example, computer-executable instructions that, when executed by one or more processors of a device, individually or collectively, cause the device to perform the operations described herein.

The flowchart and block diagrams in the Figures illustrate the architecture, functionality and operation of possible implementations of systems, methods and computer program products according to various aspects. In this regard, each block in the flowchart or block diagrams can represent a module, segment or portion of code, which comprises one or more executable instructions for implementing the specified logical function(s). In some alternative implementations the functions noted in the block can occur out of the order noted in the figures. For example, two blocks shown in succession can, in fact, be executed substantially concurrently, or the blocks can sometimes be executed in the reverse order, depending upon the functionality involved. Each block of the block diagrams and/or flowchart illustrations, and combinations of blocks in the block diagrams and/or flowchart illustrations can be implemented by special-purpose hardware-based systems that perform the specified functions or acts, or combinations of special purpose hardware and computer instructions.

What is claimed is:

1. An audio device comprising:
one or more processors being configured, individually or collectively, to:
receive an audio signal;
receive visual information associated with the audio signal; and
adjust, based on the audio signal and the visual information, at least a portion of the audio signal.

2. The audio device of claim 1, wherein the one or more processors are configured, individually or collectively, to adjust the at least the portion of the audio signal by using a trained machine-learning model to identify, based on the audio signal and the visual information, the at least the portion of the audio signal.

3. The audio device of claim 2, wherein the one or more processors are further configured, individually or collectively, to:
encode, using a pretrained audio encoder, the audio signal;
encode, using a pretrained video encoder, the visual information; and
align, in a time domain, the encoded audio signal and the encoded visual information.

4. The audio device of claim 1, further comprising:
one or more visual sensors, wherein the one or more processors are configured, individually or collectively, to receive the visual information using the one or more visual sensors; and
one or more audio sensors, wherein the one or more processors are configured, individually or collectively, to receive the audio signal using the one or more audio sensors.

5. The audio device of claim 4, wherein the one or more visual sensors comprise a camera configured to view an area external to a user of the audio device.

6. The audio device of claim 1, wherein the visual information includes facial movement information associated with speech from a speaker and wherein the audio signal includes a speech component associated with the speech and a non-speech component.

7. The audio device of claim 6, wherein the one or more processors are configured, individually or collectively, to adjust, based on the audio signal and the facial movement information, the at least the portion of the audio signal by amplifying the speech component.

8. The audio device of claim 7, wherein the one or more processors are further configured, individually or collectively, to adjust, based on the audio signal and the facial movement information, the at least a portion of the audio signal by at least partially minimizing the non-speech component.

9. The audio device of claim 8, wherein the non-speech component comprises at least one of:
background speech not from the speaker; or
environmental sound.

10. The audio device of claim 1, wherein the visual information includes information from an environment of the audio device and wherein the audio signal includes a sound component associated with the sound and a non-sound component.

11. The audio device of claim 10, wherein the one or more processors are configured, individually or collectively, to adjust, based on the audio signal and the information from the environment of the device, the at least the portion of the audio signal by amplifying the sound component.

12. The audio device of claim 11, wherein the one or more processors are further configured, individually or collectively, to adjust, based on the audio signal and the information from the environment of the device, the at least a portion of the audio signal by at least partially minimizing the non-sound component.

13. The audio device of claim 1, wherein the audio device is included in a wearable device.

14. The audio device of claim 1, wherein the one or more processors are further configured, individually or collectively, to output, for playback on the audio device, an output audio signal that includes the at least the portion of the audio signal.

15. The audio device of claim 1, wherein the visual information includes video information associated with speech from a speaker and wherein the audio signal includes a speech component associated with the speech and a non-speech component.

16. The audio device of claim 15, wherein the one or more processors are configured, individually or collectively, to adjust, based on the audio signal and the video information, the at least the portion of the audio signal by amplifying the speech component.

17. The audio device of claim 16, wherein the one or more processors are further configured, individually or collectively, to adjust, based on the audio signal and the video information, the at least a portion of the audio signal by at least partially minimizing the non-speech component.

18. A method for audio signal processing, comprising:
receiving an audio signal;
receiving visual information associated with the audio signal; and
adjusting, based on the audio signal and the visual information, at least a portion of the audio signal.

19. The method of claim 18, wherein adjusting the at least the portion of the audio signal comprises using a trained machine-learning model to identify, based on the audio signal and the visual information, the at least the portion of the audio signal.

20. A non-transitory computer-readable medium comprising computer-executable instructions that, when executed by one or more processors of a first device, cause the first device to perform a method, the method comprising:
receiving an audio signal;
receiving visual information associated with the audio signal; and
adjusting, based on the audio signal and the visual information, at least a portion of the audio signal.
